(19) United States
(12) Patent Application Publication
(10) Pub. No.: US 2015/0050539 A1
(43) Pub. Date: Feb. 19, 2015

(54) SPACER FOR A BATTERY, BATTERY AND MOTOR VEHICLE

(71) Applicant: Robert Bosch GmbH, Stuttgart (DE)

(72) Inventors: Bernd Peterl, Weinstadt (DE); Thomas Voellm, Asperg (DE)

(21) Appl. No.: 14/459,111

(22) Filed: Aug. 13, 2014

(30) Foreign Application Priority Data
Aug. 13, 2013 (DE) 10 2013 215 975.7

(51) Int. Cl. H01M 2/18; H01M 2/16

(52) U.S. Cl. CPC H01M 2/18; H01M 2/16; H01M 2220/20; H01M 10/0525
USPC 429/130

(57) ABSTRACT

A spacer (1) for a battery, said spacer comprising a frame (11), a wall (12) and at least one protruding element (13), wherein the wall (12) is disposed at least partially within the frame (11) and wherein the protruding element (13) is disposed on at least one side of the wall (12) and protrudes from the same. Recesses are thereby provided on at least two sides (111, 112) of the frame (11), whereby a fluid can flow along the wall (12) through the frame (11).

### BACKGROUND OF THE INVENTION

The present invention relates to a spacer for a battery, in particular a lithium-ion battery or a so-called lithium-ion battery pack, as well as to a battery which is equipped with battery cells and at least one such spacer. In addition, the present invention relates to a motor vehicle that has such a battery.

Sophisticated, rechargeable batteries or battery packs, i.e. an amalgamation of a plurality of individual battery cells to form a pack or an assembly, are presently used in various fields of technology. Individual battery cells can thereby be interconnected to form modules and then batteries by means of a parallel or series connection. Because a battery pack therefore relates to an amalgamation of a plurality of individual batteries, the terms “battery” and “battery pack” are used below synonymously. Application possibilities for this technology can be found, for example, in the automotive field for driving an electric motor or an electric auxiliary motor which is provided in addition to a conventional combustion engine, for example in a hybrid vehicle or the like, as well as in other technical fields, as, for example, in stationary equipment, mobile wireless phones, portable computers, video cameras or MP3 players. The lithium-ion battery technology is thereby predestined for a wide field of application, said technology being characterized, inter alia, by a high energy density and a very small self-discharge. A lithium-ion battery accordingly consists of at least one and usually of two or more lithium-ion battery cells which have at least one positive and at least one negative electrode which can reversibly intercalate or deintercalate lithium-ions.

A lithium-ion battery can only be efficiently operated in a certain temperature range. The service life of the battery is significantly reduced at an operating temperature of more than 40 degrees Celsius. The internal resistance of the battery sharply increases at temperatures under approximately 0 degrees Celsius, and the performance thereof continually decreases when the temperatures continue to fall. The temperature gradient may not exceed 5 to 10 Kelvin in a battery cell and within the battery between the cells. Lithium-ion high performance batteries for use in the automotive field are operated with very high dynamics in hybrid drive. During the brief peak loads, such as, for example, during braking, i.e. the so-called recuperation of braking energy, and during acceleration, the so-called boost support, the battery must generate a high output. These short peak loads lead to a pronounced heating-up of the lithium-ion cells due to the internal resistance. The degree of charging and discharging efficiency is very high at about 95%; however, the resulting waste heat is not negligible. In addition, outside temperatures above 40 degrees Celsius can prevail in the summer months, and therefore the operation of lithium-ion batteries without cooling can also present a safety risk in certain circumstances besides impairing the service life of said batteries. A service life requirement of 10 years cannot be achieved without the sufficient thermal conditioning of the battery, which requires an efficient thermal management, i.e. a sufficient cooling of the battery at high temperatures.

In order to cool the battery modules, the use of cooling plates has already been known for a long time in accordance with the prior art. In an alternative solution, air is used as a cooling medium, wherein the air is thereby intended to be passed by the cells, said air in turn absorbing waste heat and being subsequently discharged from the cells. In order to achieve this end, the possibility must however first exist in a battery cell amalgamation for air to be able to be passed by the battery cells. An improved air cooling system which is already known uses plastic holders, so-called spacers, which electrically as well as thermally separate the battery cells of a battery pack from one another. In this way, air can then be circulated around the freely accessible cell surfaces; thus enabling a substantially homogenous temperature distribution within a module to be achieved. A solution is known, for example, from the American patent application U.S. Pat. No. 6,689,510 B1 in which a battery pack consists of a plurality of battery cells that are inserted into a battery housing, wherein the individual battery cells are spaced apart from one another by means of respective cell separating elements. At least one channel is provided in each of said cell separating elements, through which a cooling fluid, such as, for example, air, flows in order to dissipate heat from the adjacent battery cells. When cooling down a lithium-ion battery in motor vehicles, the cool air can be passed by the surfaces of the battery cells and possibly further components via a fan. Because the cells are sometimes disposed very close to one another due to the small amount of installation space that is available, the effectiveness and efficiency of the cooling process is only limited. Thus, new challenges in the geometric configuration of the cooling system arise in order to optimize the heat transfer and achieve as high a cooling efficiency as possible.

### SUMMARY OF THE INVENTION

It is therefore the aim of the invention to increase the efficiency and effectiveness of the air cooling system for the temperature control of battery cells and other components in rechargeable batteries.

In order to meet the aim mentioned above, the invention provides a spacer, said spacer being provided for a battery, preferably for a lithium-ion battery. In addition, provision is made in the present invention for a battery which includes an inventive spacer as well as for a vehicle, preferably an electric vehicle or a hybrid vehicle, comprising such a battery.

The inventive spacer for a battery comprises a frame, a wall and at least one protruding element or, respectively, a protruding shoulder, wherein the wall is disposed at least partially within the frame, that is, so as to be understood as a center wall, and wherein the protruding element is disposed on at least one side of the wall and protrudes outwardly from the same. Recesses, by means of which a fluid can flow along the wall through the frame, are thereby provided on at least two sides of the frame.

The term “spacer” refers to a component which, when arranged between two adjacent objects, creates a certain distance between said objects so that the two adjacent objects do not directly adjoin one another. When arranging a plurality of battery cells in a battery, the disposal of a spacer between two battery cells can suppress a direct contact between the two battery cells or ensure a certain distance is maintained between the same, said distance being understood as an air ventilation duct or air duct. The spacer preferably consists of a thermoplastic material, such as, for example, a thermoplastic resin or an aluminum material. When using metallic materials for the spacer in the application as a spacer between two battery cells, the electrical insulation between the battery cells must however be ensured by the use of suitable measures. Said suitable measures can, for example, include applying an insulating coating to the spacer or the like.

The term “frame” refers to a high structure comprising side walls which enclose an interior space on two sides. The configuration of the frame has thereby a longitudinal dimension and a width dimension, which define the general surface area of the frame, as well as a depth dimension which defines the depth or, respectively, height of the frame. A hollow ashlar shape is thereby preferably understood by the term “frame” which has 4 side walls and the base areas of which are not equipped with a wall. The ashlar is thus continuous in the longitudinal direction, i.e. transversely to the side walls. The side walls can thereby, in particular in the case of the ashlar shape, consist of straight surface elements which are connected to each other at right angles. It is thereby conceivable for the connecting regions of the surface elements to be rounded off, that is the right angles are rounded off in order, for example, to achieve a modified flow of the fluid.

The term “wall” refers to a surface, the thickness or depth dimension of which is relatively smaller than the width dimension and longitudinal dimension thereof. The wall can thereby be a continuously closed wall or also alternatively thereto comprise continuous recesses which connect the regions to be separated by the wall to one another. With regard to the spacer according to the invention, the wall can connect at least two opposite frame sides to one another; said wall preferably connects all of the frame sides to one another.

The term “protruding element” can refer to any type of protrusion or protruding shoulder, provided that said element rises from the base on which it is disposed, such as a wall side of the previously mentioned wall, and in so doing protrudes from the same. In the case of the spacer according to the invention, an appropriate protruding depth or protrusion height is between 2 mm and 10 mm and furthermore preferably between 4 mm and 6 mm, in particular 4.5 mm. The height of the contact points determines the distance between the battery cells and thus the cross section of the air duct that is available for the cooling process. Said air duct can be varied via the protrusion height depending on the energy content and size of the battery cells being used or depending on the amount of thermal output to be discharged.

The term “recess” refers to a hollow space with regard to the spacer according to the invention. Said hollow space can also be continuous, that is can form a through-hole. The recesses in the frame are to be understood in the sense of ventilation slots through which a ventilation medium or a fluid as a ventilation fluid can flow.

A fluid which can flow through the recesses in the frame along the wall is preferably a cooling fluid, as, for example, cooling air. The cooling air can thereby be, for example, an airstream when the spacer is used in a vehicle. The cooling air can however also be blown through the recesses into the interior of the frame by means of a fan or something similar. It would also be conceivable in this case for another cooling gas to be used instead of air, such as, for example, carbon dioxide or ammonia. Because the cooling gas can however come directly in contact with the battery cells or the insulation thereof, it should thereby be ensured that sustainable material compatibility between cooling gas and battery cell or battery cell insulation is provided while maintaining the electrical insulation values. When using such a cooling gas, a cooling system that is closed to the outside or a cooling circuit that is closed to the outside is furthermore preferable. Alternatively, it would also be conceivable for a coolant to be used, such as, for example, cooling water or cooling oil. Because the coolant can however come directly in contact with the battery cells or the insulation thereof, it is thereby to be ensured that sustainable material compatibility between coolant and battery cell or battery cell insulation is provided while maintaining the electrical insulation values. When using such a coolant, it is furthermore preferable to use a cooling system or a cooling circuit that is closed to the outside.

In a preferred embodiment of the invention, the spacer can have a plurality of protruding elements which are disposed on at least one side of the wall so as to be spaced apart from one another and thus protrude from the same. It is furthermore preferable for a plurality of protruding elements to be disposed on each side of the wall. The arrangement of the wall in the frame of the spacer, together with the protruding element or, as the case may be, protruding elements, can significantly increase the total heat dissipating surface. This results from the spacer getting an additional cooling surface by means of the wall, wherein said additional cooling surface connects the exterior surfaces of the frame which are provided with ventilation slots. In so doing, said cooling surface has a defined number of contact points available, which are formed by the protruding elements and ensure the heat conduction between the exterior side of each of the battery cells and said cooling surface when the spacer is disposed between two battery cells. At the same time, the heat radiated by the battery cells can also be absorbed by the cooling surface. The cooling medium, preferably cooling air, can thereby be passed over the surfaces of the battery cells and possibly further components via the ventilation slots of the battery cells, for example with the aid of a fan. At the same time, the cooling medium likewise flows around the additional cooling surface of the spacer, which is provided by means of the wall; thus enabling the convection to be optimized and a larger amount of heat to be dissipated.

The at least one protruding element has preferably a cylindrical shape, which correspondingly protrudes forwards from the wall, so that the protruding element has a circular form in cross section. As a result, an improved circulation flow around the protruding element by the cooling medium can, inter alia, be achieved. The protruding element further preferably comprises at least one recess. The recess is thereby provided in the portion of the protruding element that protrudes from the wall, more precisely stated in an end face of the protruding element, wherein the recess preferably extends along the longitudinal axis of the protruding element, that is from the end face of the protruding element to the wall surface from which the protruding element protrudes. In a specific embodiment, each protruding element has a plurality of recesses, for example a central, circular-shaped recess as well as a plurality of quadrant-shaped recesses which are disposed in a circular form around the central recess. The recesses serve, inter alia, to provide mechanical stability and additionally ensure a weight reduction. As a result of the smaller material volume, less heat energy is absorbed by the material itself and can therefore dissipated faster to the cooling air.

It is furthermore preferred that the wall of the inventive spacer is disposed centrally in the frame in the depth direction of said frame; that is the wall divides or halves the frame in the depth direction thereof. The wall is thus disposed in the frame such that the wall separates the space between the two battery cells in the middle, whereby two interstices that are independent from one another are formed between the wall and each battery cell. The wall can thereby be disposed completely within the frame, or the wall can also alternatively protrude beyond the frame or, respectively, the side walls thereof. The wall is furthermore preferably a continuously closed wall; thus enabling the two interstices to be sealed off from one another in a fluid-impermeable manner at least by means of the wall. As a result, it can be assured that the cooling fluid continuously flows by the respective wall surface.

In order to further improve the thermal conduction between battery cell surface and the wall designed as a spacer cooling surface, a thermoconductive coating is provided at least on the protruding element or on the plurality of protruding elements; that is applied to the contact points. The thermoconductive coating can thereby be a thermal heat sink paste or the like. This is conceivable for the entire cooling surface, i.e. also on at least a portion of the wall or on the entire wall surface; thus enabling the convection to also be further improved here.

According to a further aspect of the present invention, a battery or a battery pack is provided, in particular a lithium-ion battery or the like, which is equipped with an inventive spacer that was previously described. The battery thereby comprises two battery cells, preferably lithium-ion battery cells, and at least one inventive spacer, wherein the spacer is disposed between the battery cells and each battery cell rests on at least one protruding element or has an abutting connection with the same, so that an interstice is present between battery cell, wall and the at least one protruding element; thus enabling a fluid to flow between the wall and the battery cell past the at least one protruding element. As an alternative, the battery can consist of a plurality of battery cells, wherein at least one spacer is disposed in each case between two battery cells and wherein the respective battery cell or an exterior wall of the respective battery cell abuts against one or a plurality of protruding elements. By means of this configuration of the spacer or, respectively, the arrangement thereof in a battery, the total heat dissipating surface can be doubled per battery cell, wherein the spacer obtains an additional cooling surface as a result of the interior wall which connects the exterior surfaces of the spacers, which are provided with ventilation slots, to one another. As a result, the aforementioned battery cooling surface has a defined number of contact points available which ensure the thermal conduction between exterior side of the battery cell and cooling surface, wherein the radiated heat can simultaneously be absorbed by the cooling surface. As already indicated above, the cooling air can be passed by the surfaces of the battery cells via the ventilation slots of the spacer exterior surface with the aid of a fan, wherein the cooling air now likewise simultaneously flows around the cooling surface of the spacers; thus enabling the convection to be optimized and a larger amount of heat can be dissipated.

In an arrangement of more than two battery cells per battery, a spacer can in each case be disposed between two battery cells, wherein the spacers are preferably connected to one another via a plug connection which is provided on the exterior side of the frame of the spacers, for example integrally embodied with the frame or alternatively as a separate part that can be mounted to the frame, for example by adhesive bonding or something similar.

According to a further aspect of the present invention, a motor vehicle is furthermore provided, preferably an electric vehicle or a hybrid vehicle comprising such a battery or such a battery pack.

By the use of an efficient heat transfer in the air cooling system as said heat transfer is achieved by means of the inventive spacer used in a battery, a simple and cost effective cooling system for batteries can be improved so that the degree of efficiency thereof is increased. An even more homogenous temperature distribution results between the battery cells due to the larger number of freely available surfaces, and the heat within the battery or the battery module can be dissipated faster. In so doing, the service life of all of the battery components is further increased, and the reliability and safety of the battery are also increased.

### BRIEF DESCRIPTION OF THE DRAWINGS

FIG. 1 shows a side view of a preferred embodiment of the spacer according to the invention;

FIG. 2a shows a top view of the preferred embodiment of the inventive spacer depicted in FIG. 1 from the direction A-A;

FIG. 2b shows a cross sectional view of the preferred embodiment of the inventive spacer depicted in FIG. 1 along the line B-B; and

FIG. 3 shows a side view of a battery comprising a plurality of battery cells and spacers disposed between said cells according to the preferred embodiments depicted in FIGS. 1 to 2b.

### DETAILED DESCRIPTION

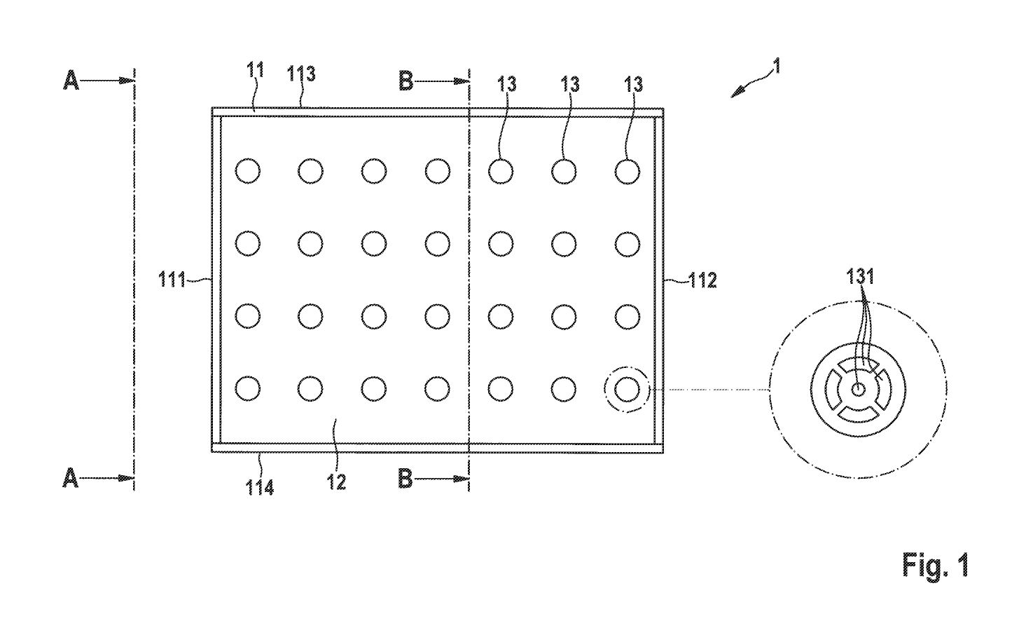

A spacer 1 according to a preferred embodiment of the invention is shown in a side view in FIG. 1. The spacer 1 comprises a frame 11 which is formed from two sides or side sections 111, 112 as well as a top or a top section 113 and a bottom or bottom section 114. The frame 11 of the preferred embodiment of the invention has here a substantially square shape, wherein the side sections 111, 112 are connected to the top section 113 and, respectively, the bottom section 114, for example by means of a one-piece cast iron construction of the frame 11, by an adhesive bonding of these elements, a welding of these elements or something similar. The spacer 1 furthermore has a wall 12, also denoted as a central wall or middle wall which is disposed substantially centrally or at a central position in the frame 11 in a depth dimension of the spacer 1, i.e. in a dimension which is directed into the drawing plane of FIG. 1. The wall 12 is connected to the frame 11 so that a continuous transition exists between frame 11 and wall 12, for example by means of a one-piece cast iron construction of the frame 11 together with the wall 12, by adhesively bonding these elements, welding said elements or something similar. In the embodiment shown and described here, the wall 12 is a continuous wall 12 which correspondingly does not comprise recesses, through holes or the like. In an alternative embodiment, such recesses can however be provided if appropriate.

The central wall 12 is furnished with protruding elements or protrusions 13 in the preferred embodiment of the inventive spacer 1. In this embodiment, the protruding elements 13 are 28 in number, wherein the protruding elements 13 are distributed in a row or column arrangement over the wall 12 so as to be spaced apart from one another as uniformly as possible. In an alternative embodiment, it would be conceivable to provide a smaller or even a larger number of protruding elements 13, even in an arbitrary arrangement of the protruding elements 13 depending on the requirements, in an arrangement of the protruding elements in which said elements are offset with respect to one another or something similar. In the case of the spacer 1, the protruding elements 13 are intended, inter alia, to enlarge a contact surface or a total area of the wall 12 which increases the thermal convection for a fluid flow that runs along the wall 12. The arrangement of the protruding elements 13 can thereby be adapted in accordance with the desired fluid flow. The protruding elements 13 are provided on the wall 12, i.e. connected to the same, for example, by means of a one-piece cast iron construction of wall 12 with the protruding elements 13, by means of an adhesive bonding of said elements or by means of welding said elements or the like.

In a detailed view in FIG. 1, one of the protruding elements 13 is shown in an enlarged view. In the preferred embodiment, the protruding elements 13 have a cylindrical shape with a circular cross section, wherein recesses 131 are provided in the protruding elements 13. The recesses 13 are provided in this case in the section of the protruding element 13 that protrudes from the wall 12, more precisely stated in an end face of the protruding element 13 which extends substantially parallel to the wall 12 and is spaced apart from the same. The recesses 13 thereby extend along a longitudinal axis off the protruding element 13, that is from the end face of the protruding element 13 to the wall surface from which the protruding element 13 protrudes. The recesses 131 are configured in a certain arrangement in the preferred embodiment, in which arrangement a central, circular recess 131 as well as a plurality of quadrant-shaped recesses 131 are provided which are disposed in a circular form around the central recess 131.

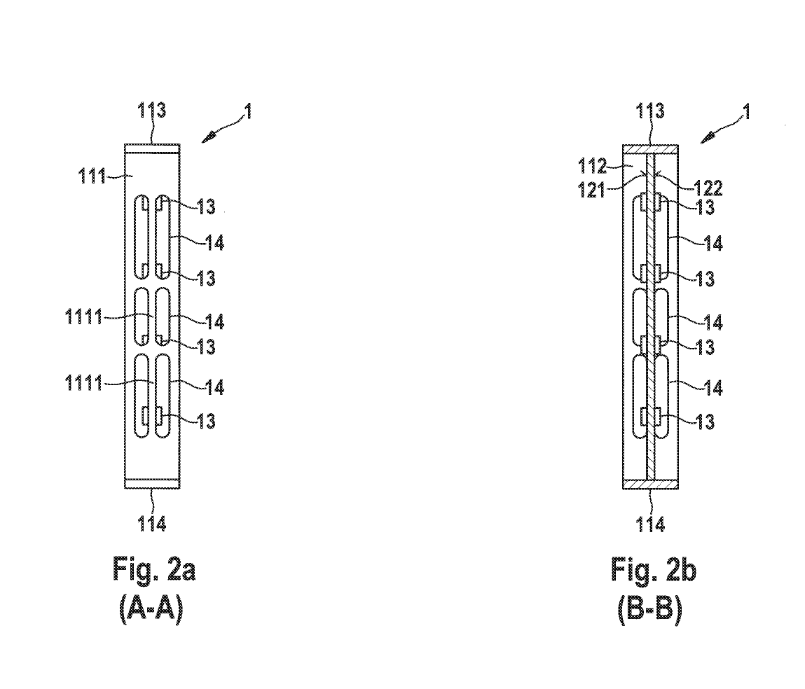

A top view is shown in FIG. 2a, thus in a view from the left side in FIG. 1, in the direction of the arrows A-A shown in FIG. 1. The side section 111 is thereby shown by way of example for the two side sections 111, 112, said side section 111 being disposed between the top 113 and the bottom 114. Recesses 14 which serve as ventilation slots are provided in the side section 111. In the preferred embodiment of the inventive spacer 1, 6 recesses are provided in an elongated, rounded shape, wherein respectively two recesses are separated by a centrally disposed web 1111. The central wall 12 extends within the frame 11 behind said web 1111. In this view, some of the protruding elements 13 disposed on the wall 12 can be seen through the recesses 14. A top view of the opposite side section 112 would be identical to the view shown in FIG. 2a. A fluid flow, which is intended to flow through the spacer 1, would flow through the recesses 14 in the side section 111 along the wall 12 and circulate around the protruding elements 13 and would flow through the recesses 14 in the side section 112 out of the spacer 1, wherein the fluid flow, which is preferably a cooling air flow, would absorb thermal energy stored in the wall 12 or in the protruding elements 13 and transport said thermal energy out of the spacer 1.

A top view of a sectional view along the line B-B in FIG. 1 is shown in FIG. 2b. As a result, the central arrangement of the wall 12 within the frame 11 can be seen, wherein the wall 12 is disposed between the top 113 and the bottom 114. The protruding elements 13 are disposed on the wall 12 and protrude away from the same from a wall surface 121 or a wall surface 122 which is opposite to the wall surface 121. The size of the frame 11 or, respectively, the size of the central wall 12 and the interior space thereby provided within the frame 11 on both sides of the wall 12 is adapted in such a way that battery cells that are intended to be spaced apart from one another by the spacer 1 can be at least partially disposed in the frame 11. The side section 112, in which recesses 14 are provided, can furthermore be seen in the view shown in FIG. 2b. The side section 112 has a design which is identical to that of the side section 111.

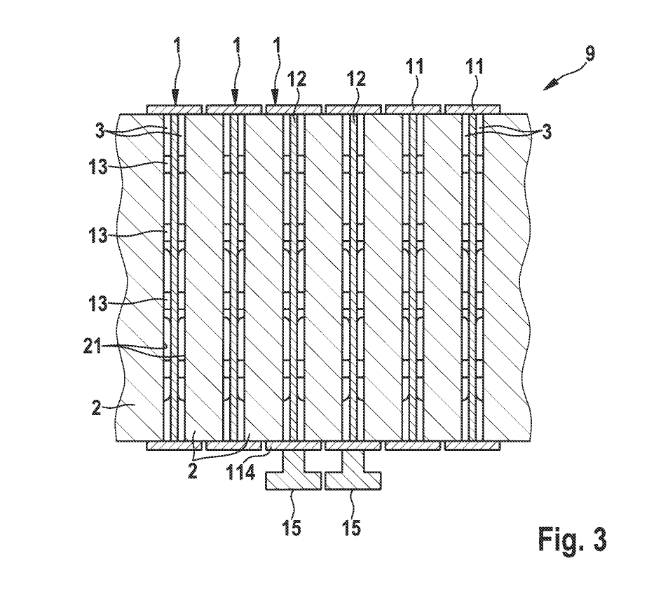

Finally in FIG. 3, a part of a battery 9 or, respectively, a battery cell pack or battery pack 9 is depicted in a lateral sectional view. The aforementioned part is substantially formed from a plurality of battery cells 2, preferably lithium-ion battery cells 2, as well as spacers 1 according to the preferred embodiment of the invention. A spacer 1 is thereby disposed in each case between two battery cells 2; thus enabling the battery cells 2 to be spaced apart from one another. The battery cells 2 are each disposed partially in the frame 11 of the spacer 1, wherein the surfaces 21 of the battery cells 2 abut against end faces of the protruding elements 13 of the spacers 1. In this way, an interstice 3 is provided between two battery cells 2 that are disposed adjacent to one another. The battery 9 or rather the arrangement of the battery cells 2 comprising the spacers 1 is achieved here by means of a plug connection using a plug connector, wherein two plug connectors 15 mounted to the bottom 114 of adjacent spacers 1 are shown by way of example in FIG. 3. Said plug connectors 15 can be provided on each spacer 1 at the bottom 114 as well as the top 113. Instead of with a plug connection, the spacers 1 can alternatively be connected to one another by means of any other type of detachable or undetachable connection and hold the arrangement of the battery cells 2 and the spacer to one another. For example, a snap connection by means of a snap closure, an adhesive connection and the like would thereby be conceivable.

A fluid flow, for example a cooling air flow, which, inter alia, can be provided by a fan or the like, can flow here through the recesses 14 in one of the side sections 111, 112 into the frame 11 of the spacer 1, i.e. into the interstices 3, past the surfaces 21 of the battery cells, the wall surfaces 121, 122 of the wall 12 as well as the protruding elements 13 and out along the recesses 14 in the other of the two side sections 111, 112 and thereby dissipate the thermal energy stored in the battery cells 2 or in the respective spacer 2 out of the battery 9. The dissipation of the stored thermal energy, thus the thermal convection, can be significantly increased here by the surface area enlargement resulting from the protruding elements 13.

What is claimed is:

1. A spacer (1) for a battery (9), comprising a frame (11), a wall (12) which is disposed at least partially within the frame (11) and at least one protruding element (13) which is disposed on at least one side (121, 122) of the wall (12) and protrudes from the wall, wherein recesses (14) are provided on at least two sides (111, 112) of the frame (11), by means of which a fluid can flow along the wall (12) through the frame (11).

2. The spacer (1) according to claim 1, wherein a plurality of protruding elements (13) is disposed on at least one side (121, 122) of the wall (12) such that said protruding elements are spaced apart from one another.

3. The spacer (1) according to claim 1, wherein the at least one protruding element (13) has a cylindrical shape.

4. The spacer (1) according to claim 1, wherein the protruding element (13) has at least one recess (131).

5. The spacer (1) according to claim 1, wherein the wall (12) is centrally disposed in the frame (11) in a depth direction of said frame.

6. The spacer (1) according to claim 1, wherein the wall (12) is disposed completely within the frame (11).

7. The spacer (1) according to claim 1, wherein a thermoconductive coating is at least provided on the protruding element (13).

8. The spacer (1) according to claim 7, wherein the thermoconductive coating is a thermal heat sink paste.

9. The spacer (1) according to claim 1, wherein the spacer (1) consists of a thermoplastic resin, a fiber composite or aluminum.

10. The spacer (1) according to claim 1, wherein a plurality of protruding elements (13) is disposed on at least one side (121, 122) of the wall (12) such that said protruding elements are spaced apart from one another, on each side (121, 122) of the wall (12).

11. The spacer (1) according to claim 1, wherein the protruding element (13) has at least one recess (131), wherein the at least one recess (131) extends along a longitudinal axis of the protruding element (13).

12. The spacer (1) according to claim 1, wherein the wall (12) is disposed completely within the frame (11), wherein the wall (12) is a continuously closed wall (12).

13. The spacer (1) according to claim 1, wherein a thermoconductive coating is at least provided on the protruding element (13), wherein the thermoconductive coating is further provided on at least a portion of the wall (12).

14. A battery (9) comprising at least two battery cells (2) and at least one spacer (1) according to claim 1, wherein the spacer (1) is disposed at least between the two battery cells (2), and each battery cell (2) abuts against at least one protruding element (13) such that an interstice (3) exists between the battery cell (2), the wall (12) and the at least one protruding element (13), thus enabling a fluid to flow between the wall (12) and the battery cell (2) past the at least one protruding element (13).

15. The battery (9) according to claim 14, wherein respectively one spacer (1) is disposed between two battery cells (2) in an arrangement of more than two battery cells (2).

16. The battery (9) according to claim 14, wherein respectively one spacer (1) is disposed between two battery cells (2) in an arrangement of more than two battery cells (2) and spacers (1) are connected to one another with a plug connection (15) which is provided on the exterior of the frame.

17. The battery (9) according to claim 14, wherein the battery cells (2) are lithium-ion battery cells.

18. A motor vehicle comprising a battery (9) according to claim 14.
